(19) United States
(12) Patent Application Publication
(10) Pub. No.: US 2019/0217545 A1
(43) Pub. Date: Jul. 18, 2019

(54) 3D PRINTER AND METHOD FOR PRODUCING OBJECTS

(71) Applicant: Wacker Chemie AG, Munich (DE)

(72) Inventors: Klaus ELLER, Burghausen (DE); Maximilian PETER, Aloetting (DE)

(73) Assignee: Wacker Chemie AG, Munich (DE)

(21) Appl. No.: 16/319,420

(22) PCT Filed: Jul. 20, 2016
(86) PCT No.: PCT/EP2016/067286

§ 371 Date: Jan. 21, 2019

(51) Int. Cl. B29C 64/393; B33Y 10/00; B33Y 50/02; B29C 64/106; B33Y 70/00; G05B 19/4099

(52) U.S. Cl. CPC B29C 64/393; B33Y 10/00; B33Y 50/02; B29K 2083/00; B33Y 70/00; G05B 19/4099; B29C 64/106

(57) ABSTRACT

A measurement system employing a confocal optical systems is used to accurately position a 3-D print head from a printing stage and a part being printed.

### CROSS REFERENCE TO RELATED APPLICATIONS

This application is the U.S. National Phase of PCT Appln. No. PCT/EP2016/067286 filed Jul. 20, 2016, the disclosure of which is incorporated in its entirety by reference herein.

### BACKGROUND OF THE INVENTION

### 1. Field of the Invention

The invention relates to a 3D printing device for manufacture of objects by the 3D printing method, having at least one printhead having at least one discharge device set up to place print materials at target positions in order to additively manufacture objects. Further aspects of the invention relate to a process for producing objects using such a 3D printing device.

### 2. Description of the Related Art

A multitude of different additive manufacturing methods is known from the prior art for production of prototypes, short runs or individual articles. What is common to these methods, also referred to as 3D printing, is that articles or objects are manufactured directly on the basis of a computer model. Advantageously, it is thus possible to manufacture customer-specific components inexpensively and easily. For production of an object, for example, a powder is selectively consolidated by applying a hardener, with application of the hardener to the powder in a pattern dependent on the object to be manufactured. Further methods include laser sintering, in which powder is consolidated by melting with a laser in the desired form according to a defined pattern, and fused filament fabrication, in which the object is produced layer by layer from a fusible plastic. There are likewise known methods in which liquid is released dropwise with nozzles and cured, for example, by action of UV radiation.

The 3D printing units are subject to mechanical tolerances in manufacture and to mechanical wear. Mechanical tolerances relate, for example, to the position and alignment of the printhead to the printing plane and the flatness of the printing plane. These tolerances affect the quality of the printed object, and so misprints can occur.

Particularly in the case of larger objects or components, the result is often inadequate printed images.

DE 10 2012 000 664 A1 describes a device for 3D printing, wherein the printing stage, for adjustment of mechanical tolerances, can be altered in its alignment to the printing plane by means of adjustable positioning screws.

DE 20 2015 103 932 U1 describes an apparatus for measurement of unevenness of a carrier plate on which an object is additively manufactured. A sensor having an immobile connection to an extrusion device is provided in order to measure the surface of the carrier plate or of the last layer printed.

DE 10 2001 106 614 A1 describes a 3D printing process which executes specific 3D prints of overhangs or self-supporting elements by means of variable alignment, positioning and inclination of the printing stage or the component holder. The printing body is aligned here by multiaxial actuators such that the printing unit can position the print voxel vertically on the printing plane. The position of the print plane is known from input data and is not ascertained or verified. This is a method with purely open-loop control and not closed-loop control.

The instruments known from the prior art have technical defects which affect the quality of the printed parts. The achievable quality of the objects, particularly in the case of the printing of silicone material, does not achieve the constant quality of comparable objects produced by means of injection molding. Nor is it possible with the known devices and methods to ensure uniform quality of the end product, as is indispensable for the industrial use of the objects produced.

### SUMMARY OF THE INVENTION

It is an object of the invention to provide an improved device and method for additive manufacture of objects, with which objects of high-quality, for example in relation to surface and trueness to shape, are manufacturable. These and other objects are achieved by a 3D printing device for manufacture of objects by the 3D printing method, having at least one printhead having at least one discharge device set up to place print materials at target positions in order to additively manufacture objects, wherein the 3D print device includes a system having at least one confocal measurement device set up to contactlessly determine a distance of the printhead from a surface on which print materials to be printed can be printed.

### BRIEF DESCRIPTION OF THE DRAWINGS

FIG. 1 a top view of a 3D printing apparatus in a first embodiment of the invention,

FIG. 2a top view of a 3D printing apparatus in a further embodiment of the invention,

FIG. 3a side view of a height measurement in a first embodiment of the invention,

FIG. 4a side view of a height measurement in a further embodiment of the invention,

FIG. 5 a side view for representation of an angle tolerance in jetting,

FIG. 6 a side view of a tilted and offset baseplate and

FIG. 7 a perspective view of a baseplate of a 3D device in one embodiment of the invention.

### DETAILED DESCRIPTION OF THE PREFERRED EMBODIMENTS

The distance of the printhead from the surface on which the print materials to be printed can be printed and the position of the printhead can be used to determine the position of a point on the surface at which a print material is to be deposited.

The 3D printing device typically comprises a baseplate on which the object is built up by discharge of print material from the at least one discharge device of the at least one printhead. Baseplate and printhead here are moved relative to one another, with relative movements being possible in all three spatial directions X, Y and Z. For this purpose, for example, the printhead may be arranged such that it is movable in X and Y direction, and the baseplate can be arranged such that it is movable in Z direction. Further configurations are also conceivable here; for example, the baseplate may be arranged so as to be movable in Y direction and the printhead may be arranged so as to be movable in X and Z direction. Alternatively or additionally, the baseplate and/or the printhead may be configured so as to be pivotable, such that any desired spatial arrangements are possible.

In order to construct an object with the print materials discharged, the print materials are deposited on the baseplate according to a defined scheme, forming a first material layer. After the first material layer has been formed, for example, the distance between the discharge device and the baseplate is increased and the next material layer is deployed. These are followed by further material layers, each of which is deposited according to a defined scheme, until the desired object has been completed. This is also referred to as additive manufacture of the object.

The print materials are discharged according to a scheme derived from a template. The template has been designed with CAD (Computer-Aided Design) software or is created by three-dimensional scanning of an article. For the derivation of the scheme for the material discharge, the software typically calculates horizontal sections of the template, with each of these sections corresponding to a material layer. Subsequently, a calculation is made as to how the print materials have to be positioned in the respective layer. What is taken into account here is whether the print materials are discharged in the form of voxels, in the form of strands, or in a combination of voxels and strands.

If appropriate, the placing of support material is also allowed for in the derivation of the scheme. The placing of support material may be necessary when the object to be produced is to have cavities, undercuts, overhanging, self-supporting or thin-walled parts, since the print materials cannot be placed free-floating in space. The support material fills cavities during the printing process and serves as a basis or scaffold in order to be able to place and cure the print materials thereon. After the printing process has ended, the support material is removed again and clears the cavities, undercuts and overhanging, self-supporting or thin-walled parts of the object. In general, the support material used is a material different from the material of the object to be printed, for example noncrosslinking and noncohesive material. Depending on the geometry of the object, the necessary shape of the support material is calculated. In the calculation of the shape of the support material, it is possible to use various strategies in order, for example, to use a minimum amount of support material or to increase the trueness to scale of the product.

The discharge device is set up to release print materials in the form of individual isolated droplets, as a series of droplets or in the form of a strand in the direction of the discharge axis. Flowing transitions between these forms are possible. In the context of this description, a droplet of a print material discharged from the discharge device and placed on the baseplate or on the object is referred to as a voxel. A strand refers to both discharged and as yet unplaced print material and to placed print material in strand form. A placed print material is understood to mean either a voxel or a strand.

For release of individual droplets, the discharge device may comprise one or more nozzles which emit liquid droplets of print material in the direction of the baseplate, similarly to the manner of the nozzles of an inkjet printer. Therefore, these nozzles are also referred to as jetting nozzles.

For release of strands of print material, the print material is expressed as a strand through a nozzle by means of pressurization of a reservoir vessel, for example from a cartridge, syringe or vat, and selectively deposited on the baseplate to form the object. Discharge devices of this kind are referred to in the context of this description as dispensers.

It is possible to provide multiple discharge devices, including those that are technically different, for various print materials in the 3D printing device. For instance, the 3D printing device may have one or more, optionally differently configured or differently operated jetting nozzles and/or one or more, optionally differently configurable or differently operated dispensers. The discharge device may also have nozzle or dispenser arrays that can simultaneously release multiple droplets or strands.

More particularly, a printhead may have multiple different discharge devices, for example one or more jetting nozzles and/or one or more dispensers. In this case, for example, the print materials can be rapidly placed in the interior of the object by means of the dispenser(s) and the surface of the object can be produced in high quality with the jetting nozzle(s). Alternatively, it is conceivable that the printhead comprises multiple equivalent discharge devices. In this way, for example, multiple objects can simultaneously be additively produced, or it is possible to work with multiple discharge devices in parallel on the construction of a single object. In both cases, the printing time required overall is reduced.

The respective discharge device has a discharge axis which defines the direction in which material is discharged from the discharge device. Typically, the discharge axis is oriented with reference to the baseplate such that it is at right angles to the baseplate. Optionally, the 3D printing device may be configured such that the alignment of discharge axis can also be altered relative to the baseplate.

Preferably, the printhead has one or more jetting nozzles. The jetting nozzles are set up such that they release a droplet in a controlled manner on demand.

It is possible to provide, for example, a heating element in the jetting nozzle, with which the print material is heated, and a droplet of a vapor bubble that arises is driven out of the jetting nozzle; this is known as a bubblejet.

A further option is the arrangement of a piezo element which deforms owing to an electrical voltage and, as a result, can eject a droplet from a jetting nozzle. Inkjet printing methods of this kind are known in principle to the person skilled in the art from conventional printing and from what is called 3D printing, in which three-dimensional articles are built up layer by layer from a photopolymerizable ink. Printheads of this kind, as used in inkjet printing or in multijet 3D printing, can also dose low-viscosity printing inks or print materials, for example those with viscosities below 50 mPa·s.

In the printheads in the method of the invention, preference is given to using discharge devices based on jet valves with piezo elements. These enable the discharge both of low-viscosity materials, where droplet volumes for droplets of a few picoliters (pL) (2 pL correspond to a droplet diameter of about 0.035 μm) can be achieved, and of moderate- and high-viscosity materials such as silicone rubber materials in particular, where preference is given to piezo printheads with a nozzle diameter between 50 and 500 μm and droplet volumes in the nanoliter range (1 to 100 nL) can be generated. With low-viscosity materials (<100 mPa·s), these printheads can release droplets with very high dosage frequency (about 1-30 kHz), whereas, with higher-viscosity materials (>100 Pa·s), depending on the rheological properties (shear-thinning characteristics), dosage frequencies of up to about 500 Hz can be achieved. Suitable jetting nozzles are described, for example, in DE 10 2011 108 799 A1.

In preferred embodiments of the jetting nozzles, on discharge of the print material, the volume of the droplet can be affected, such that droplets of different size can be generated. Alternatively or additionally, it may be the case that some jetting nozzles, for example of a nozzle array, are configured with different nozzle sizes. Small droplets can be used to produce more accurate edges and, for example, to conduct a surface finish at the lateral faces of the object after rotating the object.

In a dispenser, the pressure is built up, for example, by means of air pressure or by mechanical means, for example by a small extruder, by means of a piston pump or by means of an eccentric screw. Various embodiments are known to those skilled in the art.

In the case of a jetting nozzle as a discharge device, a control unit defines when the jetting nozzle discharges a voxel. In addition, the control unit may define the size of the voxel. It may be the case that, depending on the measurement results from the confocal measurement unit, the parameters of the jetting nozzle that affect the voxel size are adjusted. Parameters of this kind may include, for example, the opening times of the jetting valve or, if the nozzle has tappet technology, a tappet advance speed, tappet withdrawal speed, and the tappet stroke rate. The parameters of the jetting nozzle that affect the voxel size can also be briefly adjusted in the case of any reprinting of incorrectly unplaced voxels, for example in the filling of defect sites, in order to optimize the reprinting.

In the case of a dispenser as a discharge device, the control unit defines when the dispenser commences with the discharge of print material in the form of a strand and when the discharge is ended. In addition, it may be the case that the volume flow rate, i.e. the volume of print material discharged per unit time, is defined by the control unit. It may be the case that, depending on the measurement results from the confocal measurement unit, the parameters of the dispenser that affect the strand form are adjusted in order to increase the print quality. Such parameters of the dispenser may include the flow rate, feed rate and the supply pressure in the material reservoir.

If support material is used, the printhead may have one or more further discharge devices for the support material. Alternatively or additionally, it is also possible for a further printhead with appropriate discharge devices to be provided for the discharge of support material.

The print material may be material for manufacture of a permanent component, especially silicone, or it may be support material which is required for temporarily manufactured parts or regions, especially in the form of polyethylene glycol (PEG) or polyvinyl alcohol (PVAL), for example.

The print material used is preferably a material which is in a free-flowing form at least during processing and can be cured after discharge. The subsequent curability, in the case that a misprint is detected, means that a process, for example cleaning of the printhead followed by reprinting of incorrectly unplaced print materials, can be conducted, in which case the uncrosslinked materials remain free-flowing until they have been cured, such that the subsequently placed print materials can still become bonded to the print materials placed prior to the cleaning.

It is preferably the case that curing of the print materials is effected by means of radiation or by thermal means, more preferably in a location-selective manner or over the full area by means of radiation or thermal means. Preference is thus given to using print materials which, after being placed, can be cured via action of radiation or heat.

For example, in the case of the process proposed, a print material which can be cured via action of actinic radiation is used, preferably by action of UV/VIS radiation. UV radiation or UV light has a wavelength in the range from 100 nm to 380 nm, while visible light (VIS radiation) has a wavelength in the range from 380 to 780 nm.

In the method of the invention, the print materials used are more preferably silicone rubber materials that crosslink via UV/VIS-induced addition reaction. UV/VIS-induced crosslinking has advantages over thermal crosslinking. Firstly, intensity, action time and action site of the UV/VIS radiation can be judged accurately, while heating of the discharged print material (and subsequent cooling thereof) is always delayed owing to the relatively low thermal conductivity. Owing to the intrinsically very high coefficient of thermal expansion of the silicones, the temperature gradients that inevitably exist in thermal crosslinking lead to mechanical stresses which adversely affect the trueness to scale of the object formed, which in the extreme case can lead to unacceptable distortions in shape.

UV/VIS-induced addition-crosslinking silicone rubber materials are described, for example, in DE 10 2008 000 156 A1, DE 10 2008 043 316 A1, DE 10 2009 002 231 A1, DE 10 2009 027 486 A1, DE 10 2010 043 149 A1 and WO 2009/027133 A2. The crosslinking comes to rise through UV/VIS-induced activation of a light-sensitive hydrosilylation catalyst, preference being given to complexes of platinum. The prior art discloses numerous light-sensitive platinum catalysts which are largely inactive with exclusion of light and can be converted by irradiation with light having a wavelength of 250-500 nm to platinum catalysts that are active at room temperature. Examples of these are (η-diolefin)(σ-aryl)platinum complexes (EP 0 122 008 A1; EP 0 561 919 B1), Pt(II)-β-diketonate complexes (EP 0 398 701 B1) and (η5-cyclopentadienyl)tri(σ-alkyl)platinum(IV) complexes (EP 0 146 307 B1, EP 0 358 452 B1, EP 0 561 893 B1). Particular preference is given to MeCpPtMe₃ and the complexes that derive therefrom through substitution of the groups present on the platinum, as described, for example, in EP 1 050 538 B1 and EP 1 803 728 B1. The print materials which crosslink in a UV/VIS-induced manner can be formulated in one- or multicomponent form.

The rate of the UV/VIS-induced addition crosslinking depends on numerous factors, especially on the nature and concentration of the platinum catalyst, on the intensity, wavelength and duration of action of the UV/VIS radiation, the transparency, reflectivity, layer thickness and composition of the silicone rubber material, and the temperature.

The platinum catalyst is preferably used in a catalytically sufficient amount, so as to enable sufficiently rapid crosslinking at room temperature. Preference is given to using 0.1 to 500 ppm by weight of the catalyst based on the content of Pt metal relative to the overall silicone rubber material, preferably 0.5 to 200 ppm by weight, more preferably 1 to 50 ppm by weight.

For the curing of the silicone rubber material that undergoes addition crosslinking in a UV/VIS-induced manner, preference is given to using light of wavelength 240 to 500 nm, more preferably 250 to 400 nm, yet more preferably 350 to 400 nm, and most preferably 365 nm. In order to achieve rapid crosslinking, which shall be understood to mean a crosslinking time at room temperature of less than 20 min, preferably less than 10 min, more preferably less than 1 min, it is advisable to use a UV/VIS radiation source having a power between 10 mW/cm² and 20,000 mW/cm², preferably between 30 mW/cm² and 15,000 mW/cm², and a radiation dose between 150 mJ/cm² and 20,000 mJ/cm², preferably between 500 mJ/cm² and 10,000 mJ/cm². Within the scope of these power and dose values, it is possible to achieve area-specific irradiation times between a maximum of 2000 s/cm² and a minimum of 8 ms/cm².

If print materials which cure under UV/VIS are used, the 3D printing device preferably has a UV/VIS lighting unit. In the case of location-selective exposure, the UV/VIS source is arranged so as to be movable relative to the baseplate and illuminates only selected regions of the object. In the case of full-area exposure, the UV/VIS source, in one variant, is configured such that the entire object or an entire material layer of the object is exposed all at once. In a preferred variant, the UV/VIS source is designed such that its light intensity or its energy can be variably adjusted and that the UV/VIS source exposes just a subregion of the object at any time, it being possible to move the UV/VIS source relative to the object in such a way that the entire object can be exposed with the UV/VIS light, optionally in different intensity. For example, the UV/VIS source, for this purpose, is configured as a UV/VIS LED bar and is moved relative to the object, or over the printed object.

In the case of print materials that cure by thermal means, it is possible to use an infrared source (IR) in order to conduct a location-selective or areal heat treatment.

For the implementation of the curing, a curing strategy is used. Preferably, curing of the print materials follows the placing of a layer of print materials or the placing of multiple layers of print materials, or is effected directly during printing.

Curing of the print materials directly during printing is referred to as a direct curing strategy. If print materials curable by UV/VIS radiation are used, by comparison with other curing strategies, the UV/VIS source is active for a very long period, and so it is possible to work with very much lower intensity, which leads to slower crosslinking through the object. This limits the heating of the object and leads to objects that are true to scale since no expansion of the object occurs owing to temperature peaks.

In the per layer curing strategy, the placing of every complete material layer is followed by the radiation-induced crosslinking of the material layer placed. During this operation, the freshly printed layer becomes bonded to the cured printed layer beneath. The curing does not follow immediately after the placing of a print material, and so the print materials have time to relax before the curing. What is meant thereby is that the print materials can merge with one another, which achieves a smoother surface than in the direct curing strategy.

In the nth layer curing strategy, the procedure is similar to that in the per layer curing strategy, except that the curing is undertaken only after the placing of n material layers where n is a natural number. The time available for the relaxing of the print materials is increased further, which further improves the surface quality. Owing to the flow of the print materials, however, there can be a decrease in the edge sharpness achievable.

In a preferred embodiment, the curing strategy is matched to the reprinting of incorrectly unplaced print materials. For example, the printing of a material layer may be followed in each case by the reprinting of incorrectly unplaced print materials before the crosslinking of the material layer placed is effected by the per layer curing strategy or nth layer curing strategy. Incorrectly unplaced print materials can be recognized, for example, in that a position measurement unit ascertains the movement pathways of the printhead, optionally continuously, in that the discharge of the print material from the discharge device is monitored and/or in that print material discharged is measured.

The 3D print device includes a system having a confocal measurement device set up to contactlessly determine the distance of the printhead from the surface on which print materials to be printed can be printed. The system is set up to conduct a chromatic confocal distance measurement.

In general, for this purpose, the system comprises one or more sensors and evaluation units. The confocal measurement device is also referred to as the sensor of the system. The sensors make measurements that are evaluated by the evaluation unit.

The system comprises a light source. The light source is preferably implemented as a point light source, for example by means of a perforated plate having a diameter of a few micrometers or by means of an optical fiber. It emits polychromatic light onto the lens arrangement, for example broadband white light with high intensity and uniform spectral distribution.

The confocal measurement device comprises at least one lens arrangement in which the lenses are arranged confocally. The lens arrangement is configured such that the light is divided into its monochromatic wavelengths in a controlled manner. For this purpose, one or more lenses having a dispersing effect on the light are used, such that blue light components are focused closer to the lens and the red light components further away, or vice versa.

The confocal measurement device does not come into contact with the object; interaction with the object is solely through the light. On and in the object, there is reflection, absorption and transmission of the light according to the known laws of optics. The light reflected by the object, for example reflection light from the surface of the object, reflection light from the baseplate or reflection light from inclusions of air or extraneous bodies, is received by the confocal measurement device and guided via the lens arrangement to a spectrometer.

From the spectrometer measurements, the evaluation unit evaluates one or more dominant wavelengths, or spectral colors, of the light reflected. The dominant wavelengths can also be referred to as “peaks” in the context of the present disclosure. The evaluation unit is calibrated such that every wavelength of the light reflected is assigned a particular distance from the measurement object, for example from the last layer printed in the object or from the baseplate. With knowledge of the focus width of the individual wavelengths, every dominant wavelength can be directly assigned a distance value from the measurement object. More particularly, the light wavelength employed for the measurement is that which focuses exactly on the surface of the printed object (or before the printing and outside the printed object on the baseplate). The evaluation unit can use this to determine the distance of the printhead from the surface at which further print materials to be printed can be printed. If the print material is transparent, further dominant wavelengths can occur, which are also referred to as further “peaks”. Further peaks occur owing to the transition from the optically thinner medium to the optically denser medium or vice versa, for example in the case of inclusions of air or extraneous bodies in the object. A further dominant wavelength arises at the object/baseplate boundary. The surface of the printed object is the first peak, viewed from the short wavelengths, and the baseplate is the last peak. The evaluation unit may especially have software-implemented components for evaluation.

The preferred resolution of the distance measurement is in the range from 10 to 500 nm, more preferably 10 to 200 nm, yet more preferably 20 to 50 nm, and most preferably about 28 nm. The measurement range of the distance measurement is preferably in the range from 0.3 to 30 mm, more preferably 0.5 to 3 mm, and most preferably about 1 mm. The preferred size of the light spot diameter is in the range from 5 to 100 μm, more preferably 5 to 50 μm, yet more preferably 6 to 9 μm, and most preferably about 8 μm. In the X and Y directions, the confocal measurement device has an accuracy preferably between 100 and 200 μm.

If the material used is silicone rubber which crosslinks through UV/VIS-induced addition reaction, it is preferably the case that the light used for distance measurement does not contain any components that lead to unwanted curing of the silicone rubber material. If, for example, silicone rubber material that addition-crosslinks in a UV/VIS-induced manner and crosslinks under light of wavelength 240-500 nm, preferably 250-400 nm, more preferably 350-400 nm, most preferably 365 nm, it may thus be the case, in a first embodiment, that the light source of the confocal measurement device does not emit any fractions of this light, e.g. white light without fractions of this light. Alternatively or additionally, the confocal measurement device may have one or more filters in order to filter out the corresponding fractions of light.

Because the measurement does not affect the printed layers, it is especially also possible to print multiple layers one on top of another and analyze them without directly curing each layer (n-layer strategy).

The distance of the printhead from the surface on which print materials to be printed can be printed is determined in relation to the baseplate, but also in relation to already printed layers, where these, in the case of silicone or silicone elastomer, are often transparent. Preferably, the system with the confocal measurement device is therefore set up to determine the positions where the print materials to be printed can be printed on a layer formed at least partly from a transparent print material, especially on a layer comprising a silicone or silicone elastomer. Advantageously, the spectrometer and the evaluation unit of the system are set up to detect the weak reflection at the interface between two different optically dense media (e.g. air/silicone).

In a preferred embodiment, the system with the confocal measurement device is also set up to determine inclusions of air and extraneous material in printed layers.

For this purpose, the evaluation unit evaluates the position of all dominant wavelengths that occur and are detected in the spectrometer. In the case of air bubbles and in the case of transparent extraneous bodies in printed layers, further dominant wavelengths occur in addition to the object surface and to the baseplate. In the case of inclusions of nontransparent, i.e. opaque, extraneous bodies, the dominant wavelength of the baseplate, for example, moves or disappears. Defects such as inclusions of extraneous material or air bubbles can thus be recognized. If extraneous bodies or air inclusions are detected, corresponding error messages indicating a misprint can be generated. It may also be the case that the system comprises components that correct the errors, for example by additional printing of print material at defect sites or by removal of the extraneous bodies, for example by means of a robot arm.

Since the distance of the focal point from the lens is dependent on the refractive index of the medium, a distance correction is undertaken in the determination of the distance of defect sites and inclusions (for example in a transparent object). This takes account of the material-dependent refractive index of the object or of the medium.

Preferably, the system with the confocal measurement device is also set up to determine the material onto which the print materials to be printed can be printed.

For this purpose, the evaluation unit evaluates the intensity of all dominant wavelengths that occur in the spectrometer. In so doing, it distinguishes between print material, support material and baseplate material. In addition, the evaluation unit can also distinguish between materials printed alongside one another in a flat plane, for example in the application printing described hereinafter, or when a material, for example, is embedded within a further material. In order to detect the transition from a transparent material to a nontransparent material, it is also possible to use the disappearance of the reflection of the baseplate if it is still within the measurement range of the confocal measurement device.

Owing to wear or mechanical effects, there is a change in the alignment of the baseplate relative to the printhead over the course of time. In a preferred embodiment, the system with the confocal measurement device is also set up to determine the position of a printing plane in which the print materials to be printed are printed. The evaluation unit determines the position of the printing plane on the basis of multiple measured distances that are not on one line.

For this purpose, for example, a measurement matrix is used, corresponding at least to the rank of the printing point matrix. At the dispensing pressure, the measurement matrix is obtained at least partly at the rank of the position matrix of the printhead. The preferred size of the light spot diameter in the range from 5 μm to 100 μm at a resolution of the distance measurement in the range from 10 to 200 nm, for example about 20 to 40 nm, permits the measurement of every individual voxel placed.

If no material has been printed as yet, the baseplate on which the object to be printed is constructed is the printing plane. If first layers have already been printed, the printing plane may alternatively be described by the position of the last layer printed.

The position of the printing plane can be described, for example, by specification of offset and tilt with respect to the printhead or to the printhead plane, or else by specification of the distance from the printhead and the orientation in space. For this purpose, the evaluation unit has corresponding software modules.

With knowledge of the position of the printing plane, the system can be calibrated, for example by adjusting offset and tilt with respect to the printhead or printhead plane or the distance of the printing plane in relation to the respective discharge device and the orientation in space. In a preferred embodiment, the 3D printing device therefore has a correcting device which is functionally connected to the system with the confocal measurement device and is set up to correct the position of the printing plane.

The correction device may comprise adjusting elements to adjust the printing plane, for example adjusting screws on the baseplate and on the printhead. The printing plane can be adjusted mechanically by hand or automatically. Preferably, the correction device comprises actuatable actuators which can adjust, for example, the tilt and offset automatically by computer control.

If the discharge device is a jetting nozzle, the correction device may also have adjustment elements for adjustment of the alignment of the printhead, for example angle adjustment screws. Through tolerance in the mechanical properties and in the nozzle geometry, droplets deployed that lead to print voxels are not expelled perpendicularly but within a conical tolerance range. The tip of the cone is formed by the nozzle outlet and the outline of the region on the printing plane where the droplet impact occurs. Non-perpendicular alignment of the printhead, tolerances of the nozzle shape, and soiling and deposits in the nozzle or air flows can produce unwanted deflection of the droplet trajectories. Here too, actuatable actuators are preferably provided in order to be able to adjust the angle automatically by computer control.

In a preferred embodiment, the confocal measurement device is arranged at a fixed location in relation to the printhead. More particularly, it may be the case that the confocal measurement device is in a secured arrangement on a transport slide of the printhead.

Preferably, the confocal measurement device is arranged such that it precedes the printhead during the printing. In this case, any necessary corrections can be calculated and/or implemented prior to printing. It is also possible to provide multiple confocal measurement devices that may be arranged around the printhead or around the discharge device.

Further preferably, the 3D printing device has at least one controllable robot arm for positioning or manipulation of printed objects or extraneous components.

The controllable robot arm enables, for example, automatic equipping of the 3D printer with extraneous components that are to be printed, coated or printed onto whatever applications. Rotating, repositioning and removal of the extraneous component or of the printed object is also automatically possible. In addition, by means of the robot arm, extraneous material that has been recognized can be removed.

The 3D printing device has a main controller which contains a model or computer model of the object to be printed. The main controller may be executed, for example, as a computer which communicates with the control units of the devices, for example, via a data network, for example ethernet or WLAN, or via a connection, for example a serial connection or USB.

The computer model may be recorded in the main controller in any file format. Standard file formats include, for example, STL, OBJ, CLI/SLC, PLY, VRML, AMF, STEP, IGES. In the execution of the method described, the main controller produces virtual horizontal slices through the model (called slicing). These horizontal sections are subsequently used to calculate a scheme which states how the print materials have to be positioned for additive construction of the object. The scheme more particularly contains the target positions of the print materials. What is taken into account here is whether the print materials are discharged in the form of voxels, in the form of strands, or in the form of a combination of voxels and strands. If the shape of the object requires the placing of support material, the main controller is preferably set up to generate a scheme for placing of support material as well.

The main controller is functionally connected to the system with the confocal measurement device. For example, the main control system, as a result, may receive knowledge as to the positions at which print materials to be printed can be printed, such that the scheme can be updated if necessary. The further information ascertained by the system with the confocal measurement device, for example about inclusions of air and extraneous material or about the material which is to be printed, or the position of the printing plane, can also be communicated.

The main controller is additionally functionally connected to the further devices of the 3D printing device, especially to printheads, positioning units, position measurement units, print material measurements, correction devices and robot arms.

The positioning unit is set up to position the printhead relative to the baseplate, where the relative position is adjustable at least along the three spatial axes X, Y and Z, and possibly also rotatable. The positioning unit comprises at least one motor, typically with at least one separate motor provided for every adjustable spatial axis. The motor is executed, for example, as an electric motor, especially as a stepper motor.

The position measurement unit is preferably set up to constantly determine the position of the printhead. For this purpose, the position measurement unit may undertake measurements of the position of the printhead at a defined rate and transmit them to the main controller.

The position measurement unit is preferably set up to undertake a measurement of the position with reference to every axis or spatial direction adjustable by the positioning unit. The position measurement unit is at least set up to determine the position of the printhead within a plane parallel to the baseplate. It is preferably set up to determine the position of the printhead in space.

The position measurement unit preferably has at least one step counter in the motor, rotary encoder, optical scale, especially a glass scale, GPS sensor, radar sensor, ultrasound sensor, LIDAR sensor and/or at least one light barrier. The step counter in the motor may especially be configured as a contactless switch, for example as a magnetic sensor, especially Hall sensor.

A further aspect of the invention is to provide a 3D printing method. The 3D printing device described is preferably designed and/or set up to execute the methods described hereinafter. Accordingly, features described in the context of the methods are disclosed for the 3D printing device and, conversely, features described in the context of the 3D printing device are disclosed for the methods.

In a method of the invention for manufacturing an object using a 3D printing device having at least one printhead having at least one discharge device set up to place print materials at target positions in order to additively manufacture objects by means of a system having at least one confocal measurement device, during a printing operation, a distance of the printhead from a surface on which printing materials to be printed can be printed is determined contactlessly, or, in a scanning step, by means of the system having the confocal measurement device, prior to the printing operation, the position of a surface onto which materials to be printed can be printed is determined contactlessly.

During the printing operation, the distance of the printhead from a surface on which materials to be printed can be printed can be determined contactlessly. The contactlessly determined distance of the printhead from the surface on which the print materials to be printed can be printed and the position of the printhead can be used to determine, for example, the position of a point on the surface at which a print material is to be deposited. The measurement device precedes the printhead. In this way, it is possible to recognize print errors, especially unprinted print materials, defects and extraneous material deposits. The print errors can be corrected and/or reported and/or recorded.

By means of the system having the confocal measurement device, it is alternatively possible to contactlessly determine the position of a surface onto which print materials to be printed can be printed prior to the printing operation. More particularly, for example, the position of the surface relative to the printhead is determined here. The 3D printing device here conducts an independent step of scanning the surface to be printed. In this way too, it is possible to recognize print errors, especially unprinted print materials, defects and extraneous material deposits. The print errors can be corrected and/or reported and/or recorded.

The correction of the printing errors by the invention can result in printing of objects that are particularly true to shape. Trueness to shape is understood to mean that the geometric dimensions of the object are true to scale, i.e. that they have only small deviations, if any, from the dimensions of the template.

Using the contactlessly determined distance of the printhead from the surface or using the contactlessly determined position of the surface, the 3D printing device can be calibrated. As a result of this too, it is possible to print objects that are particularly true to shape.

The calibration can, as described above, relate to the adjustment of the baseplate or, after printing and subsequent measurement of a test object, to the adjustment of the discharge device, for example the angle of the nozzles.

A correction device corrects, for example, deviations in the position of a printing plane that arise as a result of mechanical wear, but also deviations that result from running of the print material in the case of inadequate or as yet incomplete curing. The correction device especially corrects the effect of the running of the layers in the case of multilayer construction with delayed curing (n-layer strategy).

A tolerable deviation in an actual position of the printing plane from a target position of the printing plane is defined, for example, by means of a threshold value, this being, for example, in the range of 50 to 500 μm, preferably between 100 and 200 μm. Alternatively, the threshold value of the tolerable deviation can be determined by the size of the printed voxels or by the strand diameter, where the tolerable deviation is fixed, for example, below half a voxel size or half a strand cross section. The tolerable deviation is defined correspondingly for the offset and tilt of the printing plane, possibly with different values.

For initial adjustment, in the scanning step, for example, it may be the case that test specimens are placed on the baseplate. The tilt and mechanical off set are ascertained from the measured positions of the surfaces of the test specimens, for example by the determining of the corners and/or edges of the test specimens.

For initial adjustment of the alignment of the printhead, defined print figures and print patterns can be printed and the printed print figures can be analyzed.

For readjustment, further scanning steps may be provided. Individual unprinted materials do not immediately and automatically call for readjustment of the baseplate, but are recognized as such by the system. In that case, the baseplate is preferably readjusted when a systematic error has been recognized by the system, for example in the event of a deviation that has been detected over a prolonged period or, for example, over a particular number of voxels, for example in more than 10 voxels or in more than 50 voxels.

In a preferred embodiment, in the scanning step, prior to the printing operation, the position of the surface onto which the print materials to be printed can be printed is determined contactlessly, and a CAD model of the surface ascertained is created. The data are generated and stored here in a known processible format.

It is thus possible to print coatings, appendages or applications on bodies of any shape. For example, bodies of uneven shape, such as lenses, can be provided with printed-on holders. In addition, coatings or buffer elements can be printed onto metallic components. In addition, an embedding print of electrodes, electrical actuators or sensors in silicone can be undertaken. The embedding may be necessary, for example, in order to make these implantable in a compatible manner to the human or animal body. Applications are in medical implants, for example hearing implants or in medical sensors. For example, electrical actuators or sensors can be produced by embedding electroactive polymers into silicone.

In addition, by the method of the invention, images of existing structures or components can be produced, especially also images of transparent components. The existing structure or component is scanned, read in as a CAD model and reprinted. Advantageously, no two separate instruments are required, and so a separate scanning unit is dispensed with.

In one embodiment, at least one extraneous component is disposed on a baseplate or on a printed layer, the position of the printable surface of the extraneous component being ascertained by the system with the confocal measurement device.

Thus, external elements can also be inserted into existing printed bodies during printing and indented within the printed body. The measurement of height ascertains the position and location of the extraneous component, and these data are processed further by the software in the printing process. The extraneous component may be fully or only partly coated with print material in the course of the printing operation or be enclosed by the print material.

The arrangement of the extraneous component on the baseplate or on the printed layer is preferably effected automatically, for example by means of a robot arm. If inaccuracies are recognized, these can be repositioned.

Extraneous components are, for example, electrical sensors, actuators, signal transducers or microchips.

In a further embodiment, after a printing operation, by means of the system with the confocal measurement device, positions of printed print materials can also be determined contactlessly.

The measurement, executed layer by layer, for example, can serve for quality control, for example. It may be the case that, for example, the difference of the target model from the actual model in the CAD model is presented. Especially in the case of undercuts and inner spaces of objects that are difficult to access, this type of documentation of quality is advantageous. A later examination would often be possible only with difficulty or to a limited degree.

In a preferred embodiment of the process, the data from the system having the confocal measurement device are used to determine and to express quality-determining indices of the printed object, especially surface roughness, surface quality, surface texture, position (especially height) and flatness tolerances. By means of the CAD data obtained, expression of quality-determining indices directly after the scan or print is executable. It is also possible in accordance with relevant standards, for example EN ISO 25178 in the 2010-2013 edition, to express immediate data relating to surface roughness from the 3D printing unit.

The printing of transparent material in particular has a multitude of fields of use, for example optical lenses. The layers onto which material is printed are preferably at least partly formed from transparent print material.

Preferably, the method proposed finds use in the production of objects that are elastomer parts, especially silicone elastomer parts. For the production of the elastomer part, preference is given to using one of the print materials described above. Elastomers, especially silicone elastomers, place specific demands on the 3D printing process since these materials, by contrast, for example, with thermoplastics, are elastic and can be deformed during the production of the object. Moreover, the uncrosslinked materials are free-flowing until they have cured.

The invention also relates to an elastomer part, especially silicone elastomer part, produced by the process proposed. The elastomer part is preferably constructed using one of the print materials described above.

The object produced by the method proposed is notable for a quality which can correspond to or even exceeds the quality of elastomer parts produced by means of injection molding. At the same time, the surface of the object can be adjusted as desired. The surface can, for example, be structured, especially given a regular structure, or may be smooth and/or completely continuous. The objects produced in accordance with the invention, owing to the option of reprinting of incorrectly unplaced print materials, also do not have any trapped air or gas bubbles. Thus, mechanically stressable objects with reliable physical properties can be produced, which are also suitable, for example, for medical applications. For example, printed objects can be provided with homogeneous elasticity or smoothness properties or, in the case of optical lenses, isotropic optical transparency. In addition, it is a feature of the printed object that its geometry is not limited by the molds used in casting methods. Thus, the printed object can have undercuts and/or enclosed cavities. The printed object is likewise free of burrs which occur in injection-molded parts especially at the separation of the mold halves and at the runner system.

The system evaluates reflections at the interfaces of material and environment. Advantageously, the confocal measurement device does not come into contact with the printed object and is of no electrostatic concern. Unwanted contamination and deformation is avoided. The solution presented, owing to the optical measurement, also gives high resolution.

The continuous, contactless detection of the distance of the discharge device from the printing plane, or from the printed object, enables compliance with the optimal deposition height of the print materials. A suitable strategy in handling the measurement result makes it possible to print objects with high trueness to shape, especially also transparent objects. The trueness to scale of the printed objects and quality-determining indices can be verified constantly.

Confocal measurement enables distance determination on substances of any hardness and any viscosity and also on transparent substances. Thus, 3D application printing is enabled on bodies of any shape, any hardness and any viscosity and transparent bodies, and also self-supporting structures with and without support material. It also becomes possible to embed bodies of any shape, any hardness and any viscosity and transparent bodies into a 3D-printed object.

More particularly, it is thus possible to execute silicone prints and application prints with silicone in such a way that it becomes possible to fulfill demands on trueness to scale that enable medical applications, for example.

The figures show working examples of the invention, although the figures show the subject matter of the invention merely in schematic form. The working examples shown and described hereinafter with reference to the figures should not be regarded as being restrictive in respect of the subject matter of the invention. A multitude of modifications possible within the scope of the claims will be apparent to the person skilled in the art.

In the description of the working examples of the invention which follows, identical or similar components and elements are furnished with identical or similar reference numerals, in which case repeated description of these components or elements is dispensed with in individual cases.

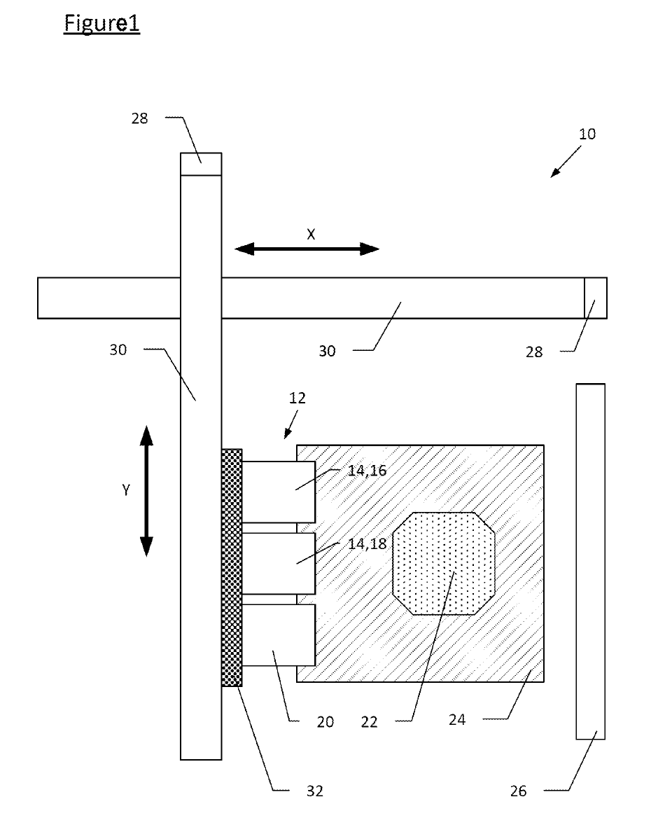

FIG. 1 shows a schematic of a top view of a 3D printing device 10 in one embodiment of the present invention. The 3D printing device 10 comprises a printhead 12 which is actuated by a control unit (not shown) via a main controller (likewise not shown). In the working example shown, the printhead 12 comprises two discharge devices 14. One discharge device 14 is executed as a jetting nozzle 16. The jetting nozzle 16 releases the print materials as individual droplets and places the print materials in the form of voxels. The other discharge device 14 is configured as a dispenser 18 and places the print materials in the form of strands.

In the example shown in FIG. 1, both the jetting nozzle 16 and the dispenser 18 are used for additive construction of an object 22. For example, with the aid of the jetting nozzle 16, voxels that form the surface of the object 22 are placed, and the dispenser 18 places strands in order to fill the interior of the object 22. The object 22 is constructed on a baseplate 24.

The 3D printing apparatus 10 has a confocal measurement device 20 which is disposed here, for example, on a transport slide 32 at a fixed location in relation to the printhead 12 on the same side as the latter, and said transport slide 32 moves the printhead 12 along the Y axis.

If print material which cures by action of UV/VIS radiation is used, a UV/VIS light source is provided. In the embodiment of FIG. 1, for this purpose, an LED bar 26 which emits UV/VIS light in a location-selective manner is provided. In order to be able to cover the area of the baseplate 24 with UV/VIS light, the LED bar 26 is designed so as to be movable.

In the case of thermally curing print materials, as an alternative, an IR light source set up for location-selective heating of the print materials is provided. For this purpose, the IR light source may especially have been secured to the printhead 12. Alternatively, for curing of heat-curing print materials, the 3D printing apparatus 10 may be operated in a heatable space.

For positioning of the printhead 12 relative to the baseplate 24, the 3D printing apparatus 10 also has three positioning units 28, two of which are shown in FIG. 1. Each of the positioning units 28 enables movement of the printhead 12 in one of the three spatial axes X, Y and Z. For this purpose, each of the positioning units 28 is connected to an axis 30 along which movement is enabled. The third positioning unit (not shown) is assigned to the baseplate 24 and enables movement of the baseplate 24 in the spatial direction within the plane of the drawing. The two positioning units 28 shown are assigned to the printhead 12 and enable movement of the printhead 12 in the spatial directions designated “X” and “Y”. All three positioning units 28 together enable positioning of the printhead 12 or in any of the three spatial directions relative to the baseplate 24. The solution shown is purely illustrative. The person skilled in the art is aware of further options.

To ascertain the position of the printhead 12, the 3D printing device 10 may have position measurement units (not shown). The position measurement units may, for example, each be assigned to one of the three spatial directions X, Y and Z, and detect the movement of the printhead 12 or of the baseplate 24, such that the relative position of the printhead 12 to the baseplate 24 is determined preferably constantly.

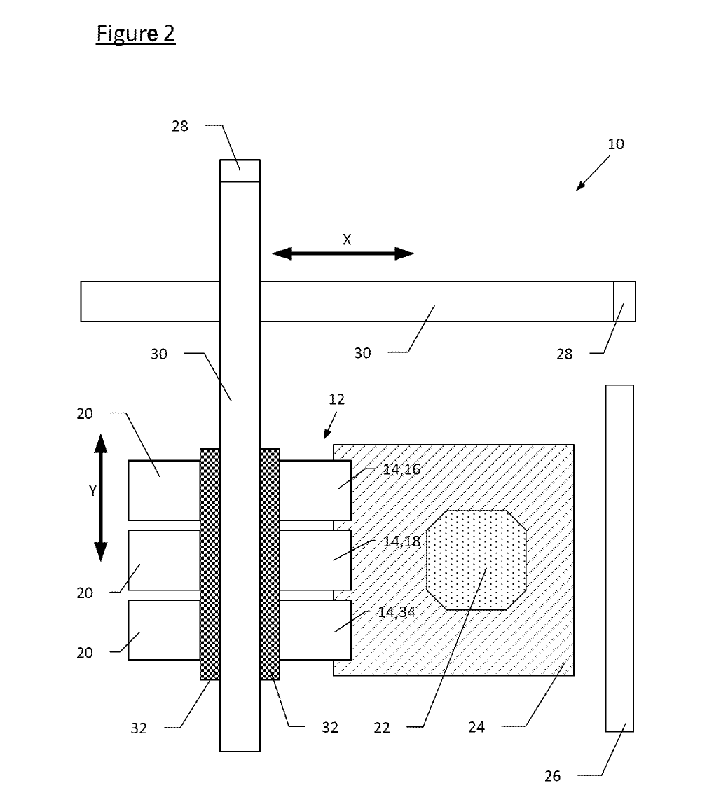

FIG. 2 shows a top view of the 3D printing device 10 in a further embodiment of the invention. The 3D printing device 10 is essentially configured as described with reference to FIG. 1. However, the 3D printing device 10 differs from the embodiment described in that three discharge devices 14 for print material are provided, and three confocal measurement devices 20.

The first two discharge devices 14 are configured as described with reference to FIG. 1. The third discharge device 14 is configured as a further jetting nozzle 34 and is provided for placing of support material.

The confocal measurement devices 20 are each assigned to one of the discharge devices 14. The confocal measurement devices 20 and the discharge devices 14 are arranged opposite one another on the transport slide 32 that moves the printhead 12 along the Y axis.

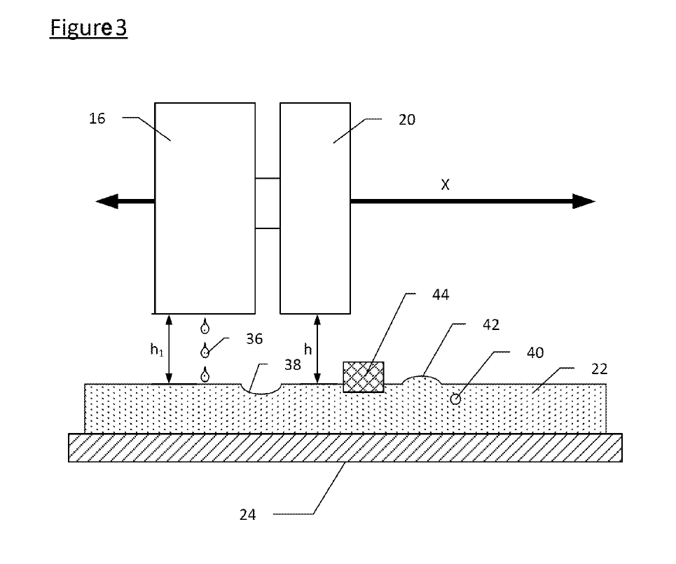

FIG. 3 shows a side view of a height measurement in one embodiment of the invention. What are shown are a jetting nozzle 16 and the confocal measurement device 20 above the baseplate 24. The jetting nozzle 16 places droplets 36 which, after hitting the object 22 or the baseplate 24, form the printed voxels.

The jetting nozzle 16 is arranged behind the confocal measurement device 20, such that, in the course of printing, there is first a measurement of height by means of the confocal measurement device 20, such that the positions at which print materials to be printed can be printed can be determined contactlessly.

The confocal measurement device 20 can also be used for prior scanning. The confocal measurement device 20 can alternatively be used such that the positions of printed print materials are determined contactlessly after the printing, for example in order to obtain a CAD model of the printed object 22.

Multiple print errors are shown on the object 22. A first print error is a defect site 38 which has already been analyzed by the confocal measurement device 20 and which can be corrected by the printing device 10 of the invention during the printing of the current layer. The 3D printing device 10 determines that merely a single or few unprinted voxels are involved, and so the defect site 38 can be remedied immediately by specific reprinting.

The printed object 22 has a further print error in the form of an air inclusion 40, i.e. a defect site 38 that has already been surrounded completely by print material. The air inclusion 40 can be recognized by the confocal measurement device 20 since multiple interfaces of print material and air occur in the measurement light beam, and so, if the air inclusion 40 is still within the measurement region of the confocal measurement device 20, there are multiple dominant wavelengths in the received signal. If the air inclusion 40 is recognized, for example, an error message can be generated or a message can be sent to the main controller such that the printed object 22 is rejected, for example, or can be subjected to further quality tests. Especially in the field of optics and medical technology, such errors as the air inclusion 40 are often impermissible and their detection is therefore necessary. In the case of an uncorrectable error, the time for recognition of the error is shortened to a minimum.

A further print error is shown in the form of elevation above the object 22 and shows a possible inclusion 42 of extraneous material that originates, for example, from the environment, for example dust particles, or may consist of the hardened material separated out from the jetting nozzle 16. The inclusion 42 of extraneous material can be recognized by the confocal measurement device 20 since the distance from the object 22 changes within a short range. The 3D printing device presented can detect whether the inclusion 42 of extraneous material is the same material as in the object 22, namely print material or support material, or another material, since the reflection properties of the interface of the environment/inclusion 42 of extraneous material are different than for the interface of environment/object 22. After detection of the inclusion 42 of extraneous material, if it is possible to detect that this is present at the surface of the object 22, i.e. through the printed layers of the object 22, corresponding warning messages can be generated in order that the user is able to intervene, or the inclusion 42 of extraneous material can be removed automatically, for example by means of a robot arm.

FIG. 3 also shows an extraneous component 44 that has been positioned on the printed object 22, for example, with the aid of a rotor arm or manually. The extraneous component 44 is to be overprinted with one or more layers of print material, so that it is ultimately embedded into the object 22. The extraneous component 44 is represented here as a cuboid, but it may also be a very flat extraneous component 44, for example an electronic printed circuit board or a microchip. After the extraneous component 44 has been positioned on the object 22, the position of the extraneous component 44 is ascertained. For this purpose, by means of the confocal measurement device 20, in the scanning step, the surface of the object 22 with the extraneous component 44 positioned therein is analyzed and the location on a surface where print materials to be printed can be printed is determined. The data ascertained can be transferred, for example, to the control system in order to create a CAD model therefrom, or in order to update the CAD model of the object 22.

The distance of the jetting nozzle 16 from the last layer printed is shown as the discharge height h₁. The distance of the confocal measurement device 20 from the last layer printed is shown as the discharge height h. The two parameters are interconvertible owing to the fixed geometry. Since the extraneous component 44 projects beyond the printed object 22 by a magnitude measured by the confocal measurement device 20 in terms of height, in the overprinting of the extraneous component 44, the distance of the jetting nozzle 16 from the baseplate 24 may be increased by the corresponding magnitude in order that the discharge height h₁ above the object 22 remains constant during the printing in order to keep the quality of the printed object 22 constant.

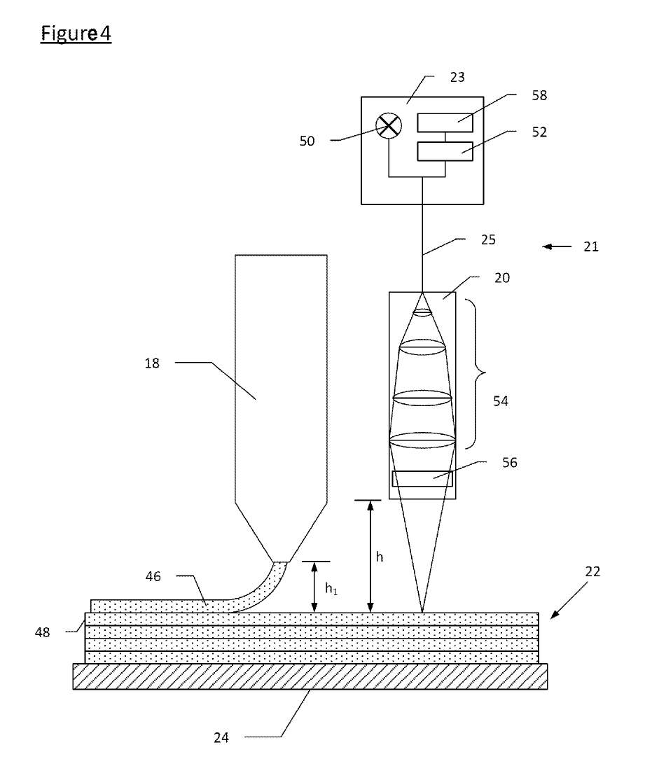

FIG. 4 shows a side view of a height measurement in a further embodiment of the invention. This shows a dispenser 18 with a confocal measurement device 20 that runs ahead on the baseplate 24 during the printing of the object 22. The dispenser 18 deposits strands 46 of print material on the baseplate 24, forming layers 48. The distance of the dispenser 18 from the last layer printed is again shown as the discharge height h₁. Given sufficient discharge height h₁, the printed strand 46 in the optimal case has a cylindrical strand cross section. The movement of the dispenser 18 slightly deforms the strand 46. Alternatively, further deformation of the strand 46 arises in the case of too small a discharge height h₁. The continuous measurement or calculation of the discharge height h₁ by the confocal measurement device 20 allows the deformation to be corrected, for example by adjustment of the discharge height h₁.

FIG. 4 also shows an embodiment of the system 21 with the confocal measurement device 20. System 21 refers in this connection to the confocal measurement device 20 and an evaluation unit 58 that are functionally connected to one another. In this working example, the evaluation unit 58 is in an integrated execution in a controller 23. The controller 23 comprises an external light source 50, a spectrometer 52 and the evaluation unit 58 in a common housing. In alternative embodiments, for example, the evaluation unit 58 and/or the light source 50 may be provided as external construction units by means of suitable interfaces.

In this embodiment shown in schematic form, the confocal measurement device 20 has a light source 50 which is, for example, a white light source having a homogeneous light spectrum, especially a white light LED. The light from the light source 50 is guided by means of an optical fiber 25 to a confocal lens arrangement 54 which, in the drawing, has been indicated by way of example by four collimator lenses. As a result of the confocal lens arrangement 54, the light emanating from the light source 50 experiences a chromatic aberration, such that blue light is more strongly refracted than red light. Beyond the confocal lens arrangement 54, in the embodiment shown, there is disposed a filter 56 that filters out those spectral components of the light source 50 that lead to unwanted curing of the printed but as yet uncured layers 48. When the light from the light source 50 hits the last layer 48 printed or the defects 38, air inclusions 40 and surfaces of extraneous components 44 that have been described with reference to FIG. 3, it is reflected at these and runs via the same light pathway, namely via the filter 56, the confocal lens arrangement 54 and the optical fiber 25 back to the controller 23, in which the reflected light is measured.

The spectrometer 52 used may be any spectrometer that divides the reflected light into its spectrum. The spectrometer 52 is connected to the evaluation unit 58. The evaluation unit 58 typically comprises a CPU and storage means, and suitable interfaces to further calculation units or to output units such as printers, monitors, etc. More particularly, it has a module for determination of the dominant wavelengths in the spectrum detected by the spectrometer 52, and a database containing assignment of frequencies of the dominant wavelength, wavelength intensity and material. The spectrometer 52 and evaluation unit 58 are thus set up to analyze single- or multilayer materials, such that the discharge height h₁ is calculable and such that, for example, the defects 38, air inclusions 40 and surfaces of extraneous components 44 described with reference to FIG. 3 are also detectable.

The confocal measurement device 20 has, in the focus region, i.e. at the surface of the object 22, a light spot diameter in the range from 5 μm to 100 μm, preferably about 50 μm. The resolution of the system 21 in the determination of the distance between the printhead 12 or the confocal measurement device 20 from the surface may be within the range from 10 nm to 0.5 μm, preferably between 20 nm and 50 nm. Preferably, the confocal measurement device 20 is designed such that it has an accuracy between 100 and 200 μm at least in X and Y direction, corresponding roughly to the size of a voxel. The accuracy is also restricted by the measurement tolerance in the mechanical properties, i.e. by the rigidity of the securing of the confocal measurement device 20 and the discharge device 14 on the transport slide 32.

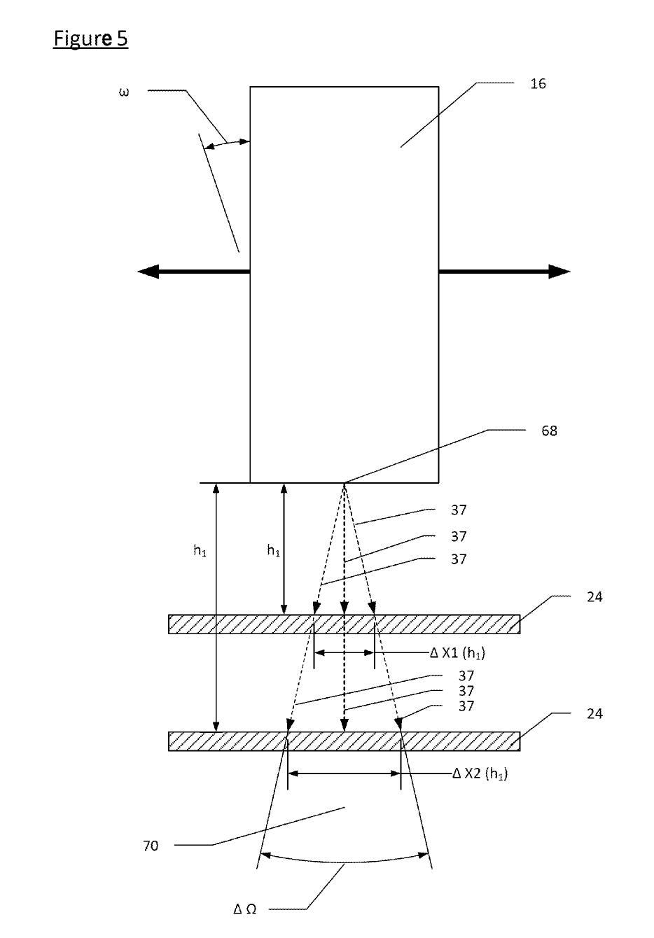

FIG. 5 shows a jetting nozzle 16 in side view above the baseplate 24, with the baseplate 24 shown at two different discharge heights h₁ relative to the jetting nozzle 16. Through tolerance in the mechanical properties and in the nozzle geometries, the droplets deployed, shown here as print jets 37, are not ejected perpendicularly but are within a certain tolerance range that forms a cone 70. The cone 70 is represented by a cone opening ΔΩ. The tip of the cone 70 forms an exit opening 68 of the jetting nozzle 16. By printing of defined print figures or print patterns and by measurement of the position or surface of the print figures, determination of the trajectory tolerance, represented in FIG. 5 by ΔX1(h₁) and ΔX2(h₁), is executable as a function of the discharge height h₁. The values obtained subsequently can be used to adjust a discharge angle ω of the jetting nozzle 16 or give guide values for an indication of wear of the jetting nozzle 16.

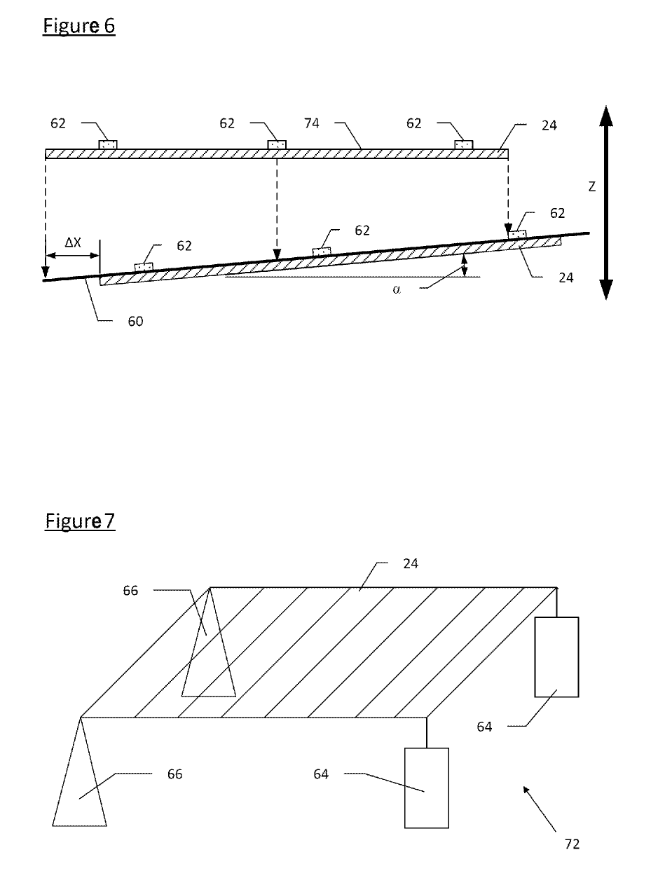

FIG. 6 shows the baseplate 24 twice in lateral section view, with test bodies 62 (three purely by way of example) spaced apart at a particular distance thereon. In the scanning operation, by measurement of the position and geometry of the test bodies by means of the confocal measurement device 20, an offset ΔX and a tilt α of the baseplate 24 can be ascertained relative to a normal position 74. The tilt and offset of the baseplate 24 in Y direction are also measured. Specification of the tilt and the offset can describe the position of a printing plane 60. After determining the tilt and the offset, the position of the printing plane 60 can be adjusted by hand or automatically to assume the normal position 74.

FIG. 7 shows a perspective view of the baseplate 24 with a correction device 72 that acts thereon. The correction device 72 is functionally connected to the system 21 with the confocal measurement device 20 via the main controller, for example, and is set up to correct the position of the printing plane 60. In the working example shown, the correcting device 72 has offset actuators 64 and tilt actuators 66, by means of which the offset ΔX and ΔY and ΔZ described with reference to FIG. 6 and the tilt α of the baseplate 24 can be adjusted.

1.-15. (canceled)

16. A process for producing a silicone elastomer part by a 3D printing device having at least one printhead with at least one discharge device configured to place print materials at target positions in order to additively manufacture the silicone elastomer part, wherein the 3D print device includes a system having at least one confocal measurement device adapted to contactlessly determine, by means of chromatic confocal distance measurement, a distance of the printhead from a surface on which print materials are to be printed, where the system comprises a light source that emits polychromatic light and the confocal measurement device comprises a lens system in which one or more lenses are arranged confocally, and which is configured such that the light from the light source is divided into its monochromatic wavelengths,
contactlessly determining a distance of the printhead from a surface on which print materials are to be printed by means of the system having at least one confocal measurement device, during a printing operation, by means of chromatic confocal distance measurement, or
contactlessly determining, the position of a surface on which print materials are to be printed in a scanning step, by means of the system having the confocal measurement device, prior to the printing operation, by means of chromatic confocal distance measurement.

17. The method of claim 16, wherein print errors are recognized and corrected and/or reported and/or recorded.

18. The method of claim 17, wherein the print errors include one or more of unprinted print materials and extraneous material deposits.

19. The method of claim 16, wherein the 3D printing device is calibrated using the contactlessly determined distance of the printhead from the surface on which print materials are to be printed.

20. The method of claim 16, wherein in the scanning step, prior to the printing operation, the position of the surface onto which the print materials are to be printed is determined contactlessly, and in that a CAD model of the surface ascertained is created.

21. The method of claim 16, wherein at least one extraneous component is disposed on a baseplate or on a printed layer, and the position of the printable surface of the extraneous component is ascertained by the system with the confocal measurement device.

22. The method of claim 16, wherein after a printing operation, by means of the system with the confocal measurement device, the positions of printed print materials are also determined contactlessly after a printing operation.

23. The method of claim 16, wherein the data from the system having the confocal measurement device are used to determine and express quality-determining indices of the printed silicone elastomer part.

24. The method of claim 22, wherein the indices include one or more of surface roughness, surface texture, position and flatness tolerances.

25. The method of claim 16, wherein material is printed onto layers at least partly formed from transparent print material.
